(19) United States
(12) Patent Application Publication
(10) Pub. No.: US 2014/0365974 A1
(43) Pub. Date: Dec. 11, 2014

(54) DISPLAY APPARATUS FOR RELEASING LOCK STATUS AND METHOD THEREOF

(71) Applicant: Samsung Electronics Co., Ltd., Gyeonggi-do (KR)

(72) Inventors: Jung-joo Sohn, Seoul (KR); Nipun Kumar, Gyeonggi-do (KR); Ji-yeon Kwak, Seoul (KR)

(21) Appl. No.: 14/368,207

(22) PCT Filed: Dec. 10, 2012
(86) PCT No.: PCT/KR2012/010681

§ 371 Date: Jun. 23, 2014

(30) Foreign Application Priority Data
Dec. 23, 2011 (KR) 10-2011-0141800

(51) Int. Cl. G06F 3/0484

(52) U.S. Cl. CPC G06F 3/04847; G06F 3/04842
USPC 715/846

(57) ABSTRACT

A display apparatus and method for releasing a lock status of the display apparatus are provided. The display apparatus includes a display unit for displaying a lock view comprising an affordance object including a plurality of blocks, the plurality of blocks including a plurality of selection blocks; and a control unit for controlling the display unit to alter a display state of each of the plurality of the selection blocks, as each of the plurality of selection blocks is touched by a user, and to switch from the lock view to an unlock view, after all of the plurality of selection blocks are touched.

### PRIORITY

This application is a National Phase Entry of PCT International Application No. PCT/KR2012/010681, which was filed on Dec. 10, 2012, and claims priority to Korean Patent Application No. 10-2011-0141800, which was filed on Dec. 23, 2011, the entire content of each of which is incorporated herein by reference.

### BACKGROUND OF THE INVENTION

1. Field of the Invention

The present invention relates generally to a display apparatus and a method for releasing a lock status thereof, and more particularly, to a display apparatus for releasing a lock status using an affordance object displayed in a lock view, and a method for releasing the lock status.

2. Description of the Related Art

Currently, use of display devices, such as smart phones or tablet Personal Computers (PCs), supporting various applications is rapidly increasing.

A typical display device includes a large touch screen so that a user can control manipulation more easily while viewing content. However, by having the large touch screen, the screen of the display device is often inadvertently touched, thereby executing an unintended function.

To avoid this, the display device often supports a lock function. When locked, i.e., in the locked status, when the screen is touched or a key is selected, no function is performed. The user can release the lock status with a preset manipulation.

The user manipulation for releasing the lock status can be defined by a display device manufacturer. For example, the manufacturer can design the lock status to be released through a predefined manipulation within a fixed part on the screen.

However, when the predetermined manipulation is repeatedly performed in the fixed part of the screen as in a conventional apparatus, pixels of the corresponding part or touch sensors under the screen may begin to degrade, thereby diminishing sensing performance.

Also, the conventional apparatus does not meet user needs for a more dynamic and interesting User Interface (UI).

### SUMMARY OF THE INVENTION

Accordingly, the present invention is designed to address at least the problems and/or disadvantages described above and to provide at least the advantages described below.

An aspect of the present invention is to provide a display apparatus with which a user can easily and intuitively release a lock status using an affordance object, and a method for releasing the lock status.

In accordance with an aspect of the present invention, a display apparatus is provided, which includes a display unit for displaying a lock view comprising an affordance object including a plurality of blocks, the plurality of blocks including a plurality of selection blocks; and a control unit for controlling the display unit to alter a display state of each of the plurality of the selection blocks, as each of the plurality of selection blocks is touched by a user, and to switch from the lock view to an unlock view, after all of the plurality of selection blocks are touched.

In accordance with another aspect of the present invention, a method is provided for releasing a lock status of a display apparatus. The method includes displaying a lock view comprising an affordance object including a plurality of blocks, the plurality of blocks including a plurality of selection blocks; altering a display state of each of the plurality of the selection blocks, as each of the plurality of selection blocks is touched by a user; and switching from the lock view to an unlock view, after all of the plurality of selection blocks are touched.

According to various embodiments described herein, a user can easily release a lock using an affordance object. Hence, concentrated use of a particular part of a screen can be prevented and the user's satisfaction can be increased.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram illustrating a display apparatus according to an embodiment of the present invention;

FIGS. 2, 3 and 4 are diagrams illustrating various lock views in a display apparatus according to an embodiment of the present invention;

FIG. 5 is a diagram illustrating affordance object change types when a lock is released, according to an embodiment of the present invention;

FIG. 6 is a block diagram illustrating a display apparatus according to an embodiment of the present invention;

FIGS. 7, 8 and 9 are diagrams illustrating an affordance object display change when a call connection request is received, according to embodiments of the present invention;

FIGS. 10 through 14 are diagrams illustrating various user manipulations, according to embodiments of the present invention;

FIG. 15 is a flowchart illustrating an unlocking method according to an embodiment of the present invention; and

FIG. 16 is a flowchart illustrating an unlocking method according to another embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

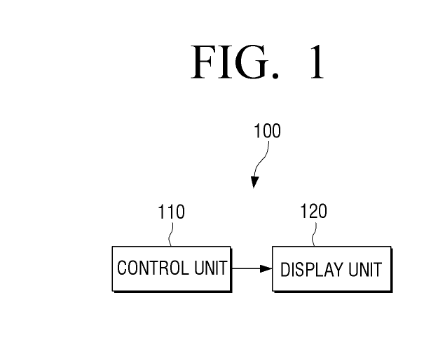

FIG. 1 is a block diagram illustrating a display apparatus according to an embodiment of the present invention.

Referring to FIG. 1, the display apparatus 100 includes a control unit 110 and a display unit 120.

The control unit 110 controls operations of the display apparatus 100. The control unit 110 can control hardware of the display apparatus 100 and support various functions by executing an Operating System (O/S) or various applications stored to a memory (not shown) of the display apparatus 100.

When the display apparatus 100 is turned on or reset, when the ongoing function of the display apparatus 100 is completed, or when there is no user manipulation or no operation of the display apparatus 100 for a certain time, the control unit 110 operates in a lock status. When an event such as user screen touch or button selection occurs in the display apparatus 100 operating in the lock status, occurs, the control unit 110 controls the display unit 120 to display a lock view.

The display unit 120 displays the lock view including an affordance object. The affordance object is an object generated to induce user manipulation. For example, the affordance object may include a plurality of blocks. Some of the blocks are displayed to be selectable. Hereinafter, a selectable block is referred to as a selection block. The selection block may be differentiated from other blocks by using different display attributes such as shape, color, size, and depth. Additionally, a highlight effect or flicker effect can be applied to the selection block for the differentiation.

When all of the selection blocks are touched on the lock view, the control unit 110 controls the display unit 120 to switch to an unlock view, while changing the affordance object to alter the display state of the touched selection blocks.

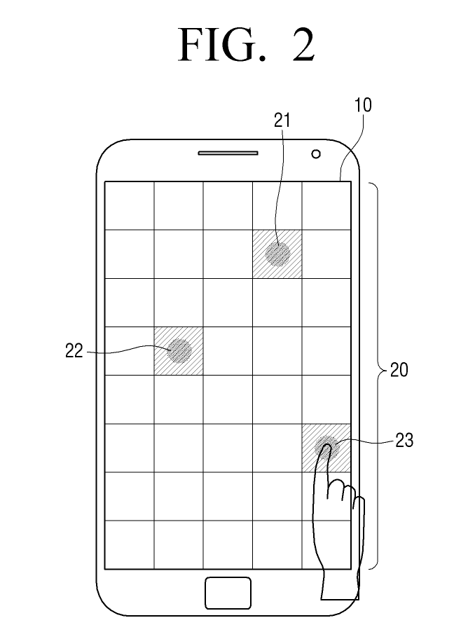

FIG. 2 is diagram illustrating a lock view in a display apparatus according to an embodiment of the present invention. Specifically, FIG. 2 depicts an affordance object.

Referring to FIG. 2, an affordance object 20 displayed on a lock view 10 is represented in a block pattern, and a plurality of selection blocks 21, 22 and 23 are displayed on the block pattern.

When the user touches the selection blocks 21, 22 and 23, the control unit 110 controls the display unit 120 to change the affordance object 20, such that the touched selection blocks 21, 22 and 23 transit to the same display state as the other displayed blocks. After the change, the lock is released and the view is automatically switched to an unlock view.

The selection blocks 21, 22 and 23 can be determined in various manners. For example, the control unit 110 can randomly determine the selection blocks from the plurality of the blocks. Hence, the locations of the selection blocks can differ each time the lock view 10 is displayed.

For example, the control unit 110 can determine a block corresponding to an updated content as the selection block among the plurality of the blocks.

That is, the plurality of the blocks each can display content individually. For example, a widget program for displaying the time, the date, or the weather or an application for sending and receiving messages can be executed and its execution result can be displayed on each block. In this case, when the content to display is newly updated or received, the control unit 110 can determine the blocks for displaying the updated content as the selection blocks.

The control unit 110 controls the display unit 120 to differentiate the selection blocks from the other blocks in the display.

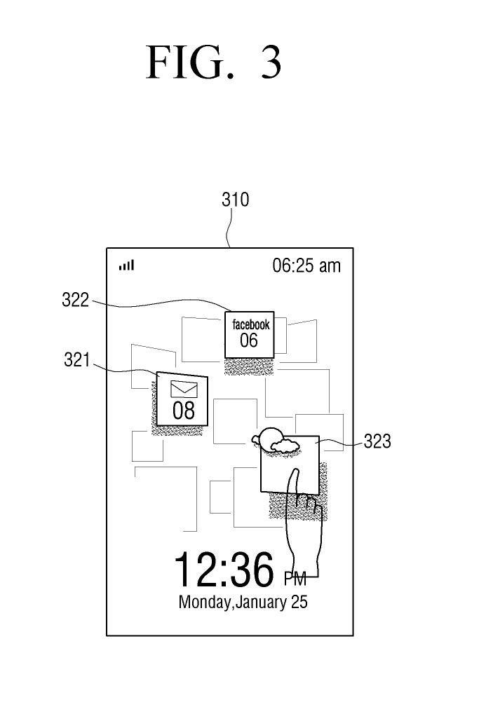

FIG. 3 is diagram illustrating a lock view in a display apparatus according to an embodiment of the present invention. Specifically, FIG. 3 depicts another affordance object.

Referring to FIG. 3, the lock view 310 displays an affordance object including a plurality of blocks irregularly arranged. Of the displayed blocks, selection blocks 321, 322 and 323 are displayed distinctively from the other blocks. The other blocks are displayed in an inactive state.

In FIG. 3, the selection blocks 321, 322 and 323 are represented as a 3D image having the depth different from the other blocks displayed in the lock view.

Upon touching, the control unit 110 controls the display unit 120 to stop the differentiation by converting the selection block touched by the user among the plurality of the selection blocks 321, 322 and 323, to a 2D image having the same depth as the lock view. The display unit 120 displays the unlock view, when the all of the selection blocks 321, 322 and 323 are converted to the 2D images.

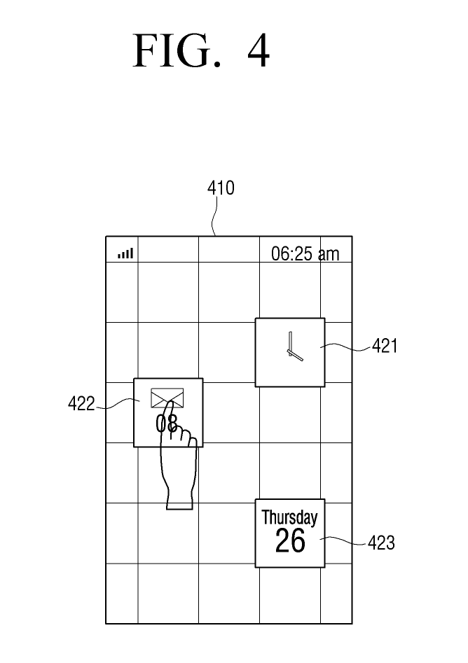

FIG. 4 is diagram illustrating a lock view in a display apparatus according to an embodiment of the present invention. Specifically, FIG. 4 depicts yet another affordance object.

Referring to FIG. 4, the lock view 410 displays an affordance object including a plurality of blocks that are regularly arranged. Of the displayed blocks, selection blocks 421, 422 and 423 are displayed as activated 2D images compared to the other blocks. The other blocks, excluding the selection blocks 421, 422 and 423, are displayed in the inactive state. To differentiate between the blocks, the selection blocks 421, 422 and 423 are displayed as color images having a larger size than the other blocks.

When the selection blocks 421, 422 and 423 are touched in FIG. 4, the touched selection block turns over, similar to the other blocks, to stop the differentiation.

The display unit 120 displays the unlock view when the all of the selection blocks 421, 422 and 423 are turned over.

Additionally, a lock view can display basic information such as time, date, weather, etc., in addition to the affordance objects as illustrated in FIGS. 3 and 4. The basic information can be displayed at adequate locations on the lock view so as not to overlap with the affordance object.

While the other blocks are displayed in the inactive state in FIGS. 3 and 4, the other blocks may also display content according to the execution result of an application program or a widget program matched to the corresponding block, even in the inactive state.

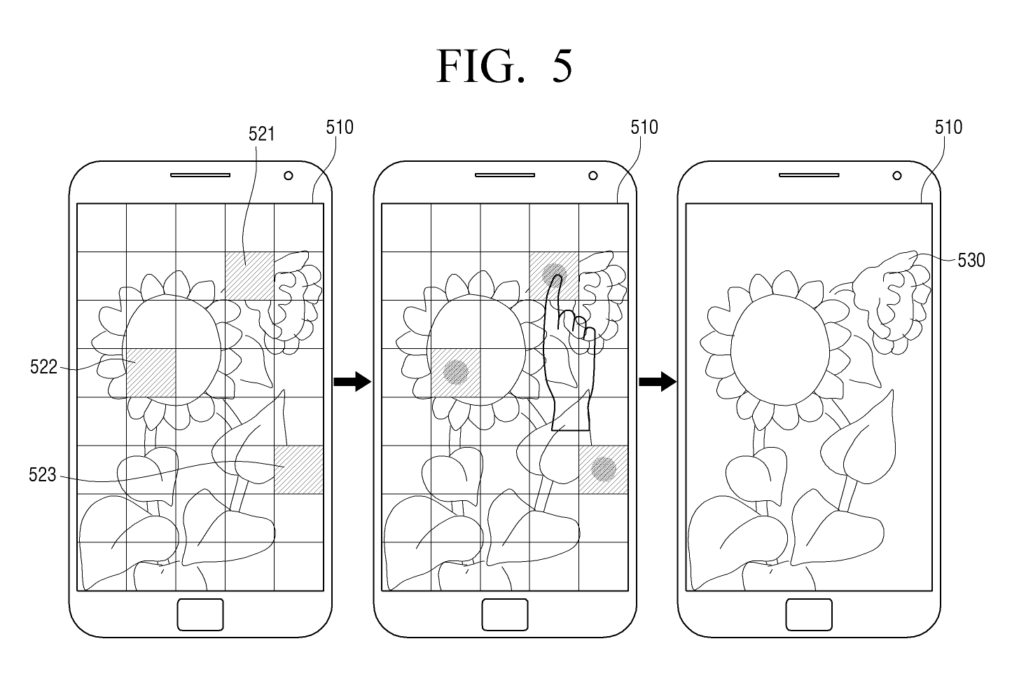

FIG. 5 is diagram illustrating a lock view in a display apparatus according to an embodiment of the present invention. Specifically, FIG. 5 depicts still another lock release.

Referring to FIG. 5, the affordance object displayed in the lock view 510 divides an image into blocks. Selection blocks 521, 522 and 523 of the divided blocks do not display the image. To unlock the display apparatus, the user sequentially touches the selection blocks 521, 522 and 523 displaying no image. When a selection block is touched, the control unit 110 controls the display unit 120 such that the touched selection blocks 521, 522 and 523 also display the image. When all of the selection blocks 521, 522 and 523 are touched, the block division display of the affordance object segmented into the blocks disappears and the original image 530 is represented. The display unit 120 displays the affordance object as the original image 530 and switches to the unlock view.

Although described as blocks, the affordance object can be implemented in various shapes. The affordance object may also be represented in other images which include a plurality of blocks. Further, the blocks are not limited to the rectangle and can be represented as a circle, a polygon, etc.

Thus, the user may enjoy releasing the lock, thus maximizing satisfaction.

The unlock view displayed after the affordance object is changed can be implemented in various shapes according to exemplary embodiments. For example, the unlock view can be an execution view generated by the execution of a particular application. When the lock is released, the execution view of an application used before the display apparatus enters the lock status, a default application, or an application frequently used can be displayed.

For example, the unlock view can use a view including an icon display region for arranging applications, widgets, folder icons, and menus installed to the display apparatus, and a fixed menu region. The fixed menu region displays menus of functions frequently used by the user, such as call, message check, Internet connection, and recent call list, or default functions.

Such an unlock view can be automatically displayed after all of the blocks displayed in the affordance object are selected and the affordance object is changed.

As described above, the affordance object is generated to include at least one selection block to induce the user's touch. Additionally, a text or an indicator image instructing the user to touch the block may be displayed beside the affordance object so that the user can more clearly understand that the selection block needs to be touched to release the lock. Alternatively or in addition, the selection block may regularly wave or flicker so that the user can intuitively recognize that the selection block is to be touched.

The display apparatus can be implemented using various devices including a TV, a table PC, a PC, a notebook PC, a digital frame, an e-book, a Personal Digital Assistant (PDA), a mobile phone, etc. A display apparatus having the communication capability, such as mobile phone, can receive a call in the lock status. In this case, the affordance object can be changed to determine whether to receive or reject the call in the lock view.

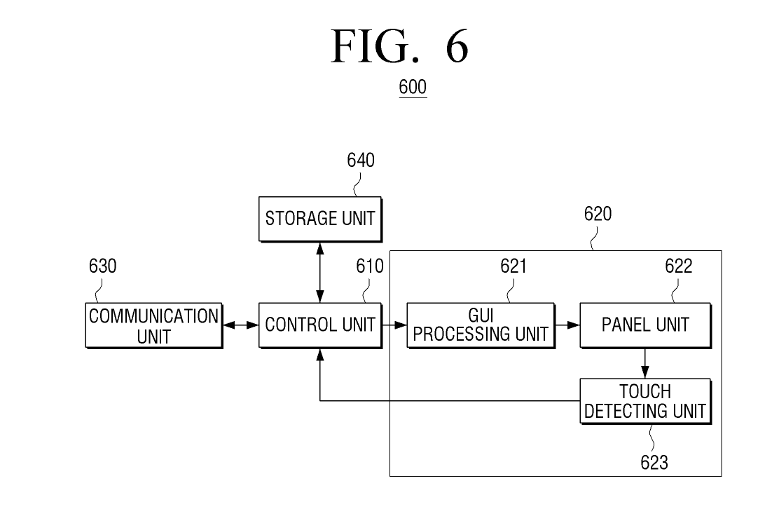

FIG. 6 is a block diagram illustrating a display apparatus according to another embodiment of the present invention.

Referring to FIG. 6, the display apparatus 600 includes a control unit 610, a display unit 620, a communication unit 630, and a storage unit 640.

The display unit 620 includes a Graphical User Interface (GUI) processing unit 621, a panel unit 622, and a touch detecting unit 623. Using setup information stored to the storage unit 640, the GUI processing unit 621 generates screen configuration data of various types such as lock view, unlock view, and application execution view. Based on the screen configuration data generated by the GUI processing unit 621, the panel unit 622 displays the view by driving hardware including, e.g., a Liquid Crystal Display (LCD) display panel and a backlight unit. The touch detecting unit 623 provides coordinates of the user s touch point to the control unit 610 using a touch sensor equipped in the panel unit 622.

The control unit 610 controls the GUI processing unit 621 and the panel unit 622 to output the view corresponding to the current status of the display apparatus 600. Using the coordinates provided from the touch detecting unit 623, the control unit 610 calculates the user's touch point, touch trace, and movement speed. Based on the calculation results, the control unit 610 determines whether to tilt the affordance object.

The storage unit 640 stores 0/S, applications, widget programs, data, etc. In particular, the storage unit 640 can store information relating to at least one of the various affordance objects as described above.

The control unit 610 can be driven by the 0/S stored to the storage unit 640 to execute various applications or widget programs selected by the user and to carry out the function. When it is necessary to switch to the lock status, the control unit 610 enters the lock status so that the display apparatus 600 does not respond to any key manipulation or any touch of the user. When the user arbitrarily manipulates the key or touches the screen in the lock status, the control unit 610 controls the display unit 620 to generate and display the lock view.

The communication unit 630 receives a call connection request, e.g., over a telephone network. When the call is connected, the communication unit 630 converts the user's input voice to a voice signal, transmits to the other telephone over the telephone network, converts a voice signal received from the other telephone, and provides to a speaker (not shown).

When the selection block of the affordance object is touched in the displayed lock view, the control unit 610 controls the display unit 620 to change the affordance object to alter the display state of the touched selection block and to switch to the unlock view.

When the affordance object splits the single image into the plurality of the blocks, the storage unit 640 can store various images usable as the affordance object. Such images can be received from an external server or imaging device, or stored as the default images to the storage unit 640.

The control unit 610 can randomly select the image to be used as the affordance object in the storage unit 640. Hence, the affordance object can differ in every lock view.

In the lock status with the lock view displayed, when the call connection request is received through the communication unit 630, the control unit 610 can modify the form or the number of the affordance object so that the user can select whether to connect or reject the call.

When the call connection request is received through the communication unit 630, even in the unlock status, the control unit 610 can control the display unit 620 to display the affordance objects with which the user can select whether to connect or reject the call.

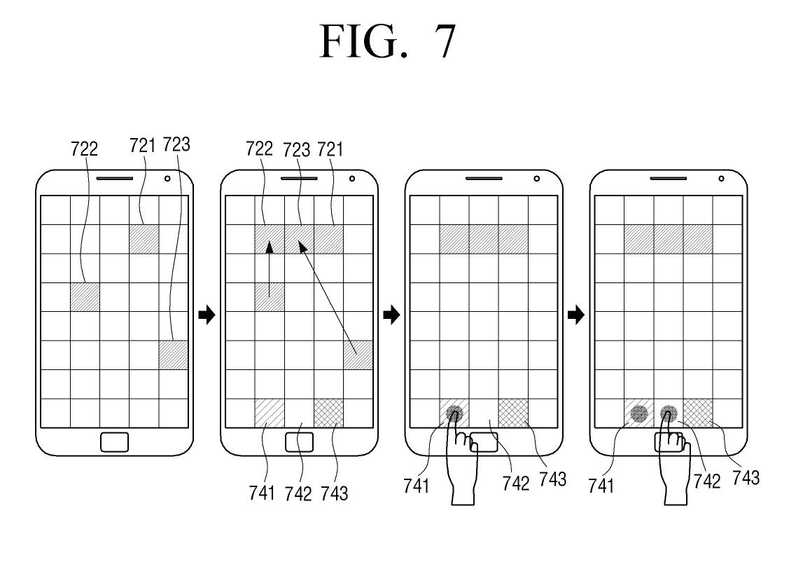

FIG. 7 is a diagram illustrating a lock view change when a call connection request is received according to an embodiment of the present invention.

Referring to FIG. 7, when the call connection request is received while an affordance object with a block pattern including a plurality of the selection blocks 721, 722 and 723 is displayed, the selection blocks 721, 722 and 723 move to and gather at a particular location on the lock view. Caller information can be displayed in the selection blocks 721, 722 and 723 gathered at the particular location. For example, the call information may include information such as image, name, or phone number of the caller.

Using the caller number of the call connection request received at the communication unit 630, the control unit 610 can read various caller information stored to the storage unit 640. The read caller information is provided to the GUI processing unit 621 of the display unit 620. The GUI processing unit 621 generates data to be displayed in the selection blocks 721, 722 and 723 using the caller information. The generated data is provided to the panel unit 622 to display the caller information.

Together with the display movement of the selection blocks 721, 722 and 723, the view displays new selection blocks 741, 742 and 743.

Individual functions may be mapped to the new selection blocks 741, 742 and 743. For example, the first selection block 741 can be mapped to a call connection function, the second selection block 742 can be mapped to a call connection rejection function, and a third selection block 743 can be mapped to an OK function for the selected function. These functions are merely exemplary and the mapping manner or the mapping functions can vary according to different embodiments.

The user can perform an intended function by touching the new selection blocks 741, 742 and 743. For example, when the block mapped to the call connection function is touched, the lock view is switched to a call connection view (not shown). When the block mapped to the call connection rejection function is touched, the call connection is terminated and the lock view is displayed again.

The call connection request can be received outside of the lock status. In this case, the control unit 610 can control the display unit 620 to display the affordance object, as described above. Hence, a corresponding function can be performed according to the selection stats of the block of each affordance object.

There can be various operation modes in addition to the call connection request received, for example, a mode for checking a received text message or mail, a power-save mode due to the lack of the remaining battery capacity, and a mode for outputting an alarm signal when an alarm set time arrives. In these different modes, the control unit 110 can enter various operation modes such as mail check mode, power-saving mode, and alarm output mode.

Upon entering such an operation mode, the control unit 610 can control the display unit 620 to display the affordance object including the plurality of the new selection blocks respectively mapped to the new functions selectable in the corresponding operation mode. For example, when the text message or mail is received, the function for checking the text message or mail and the function for checking the caller information or postponing the text message or mail check can be mapped to the new function blocks.

When the alarm set time arrives and the alarm output mode for outputting the alarm signal is transited, the control unit 610 can map an alarm stop function or an alarm reset function after 5 minutes to the new selection block.

When entering the power-save mode, a function for returning to the normal mode and a function for maintaining the power-save mode can be mapped to the new selection blocks.

As such, the affordance object can be used in various operation modes.

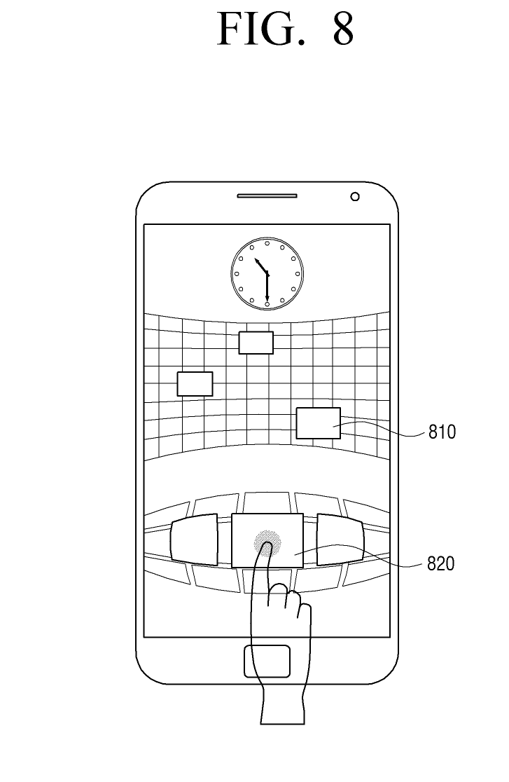

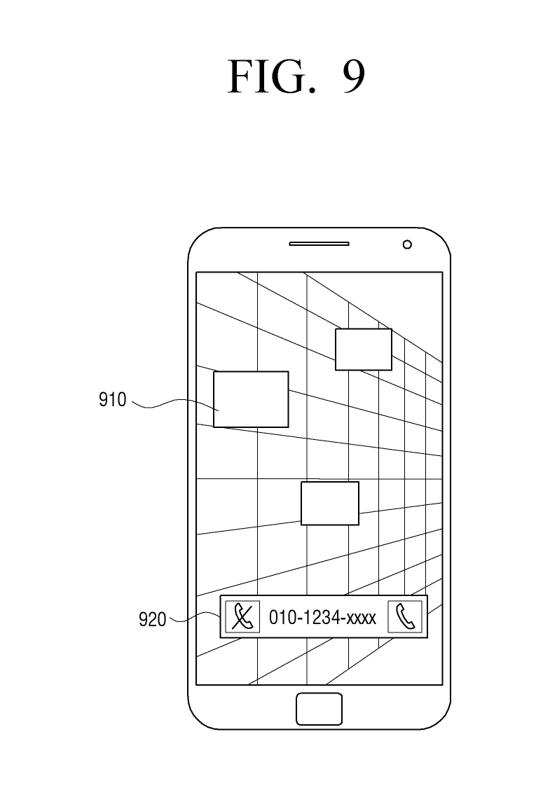

FIGS. 8 and 9 are diagrams illustrating an affordance object display change when a call connection request is received, according to embodiments of the present invention. Specifically, FIGS. 8 and 9 depict lock views including affordance objects according to embodiments of the present invention.

Referring to FIG. 8, the selection blocks 810 are randomly determined among the plurality of the blocks and discriminately displayed. Besides the selection blocks 810, fixed blocks 820, which are mapped to particular functions, are displayed in a region of the view.

Referring to FIG. 9, the blocks are arranged in three dimensions and selection blocks 910 are displayed. In this case, when the call connection request is received, the view displays a message 920 for selecting to connect or to reject the call.

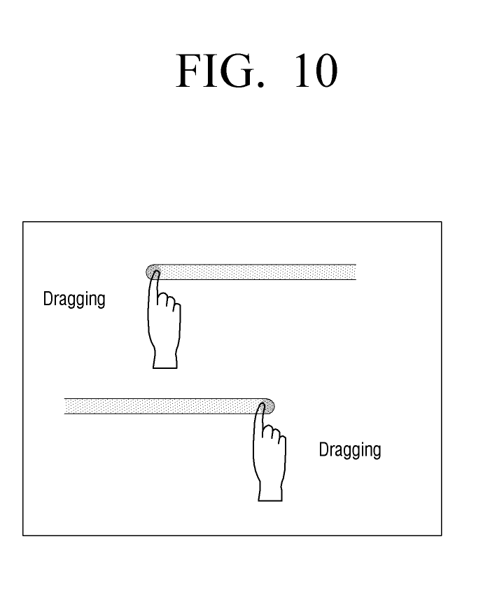

FIGS. 10 through 14 are diagrams illustrating various user manipulations, according to embodiments of the present invention.

Specifically, FIG. 10 illustrates a user drag operation, which touches a point and moves to another point while still touching.

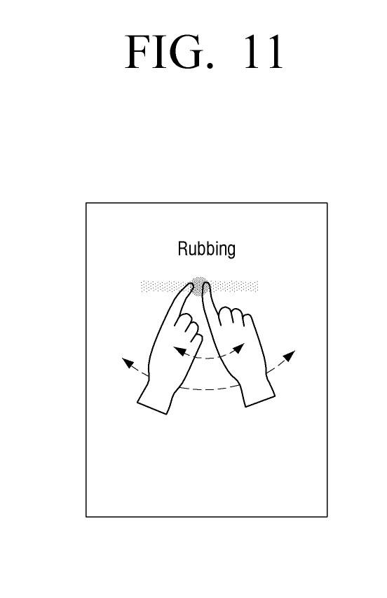

FIG. 11 illustrates a user rubbing operation, wherein user touches a point and moves forward and backward.

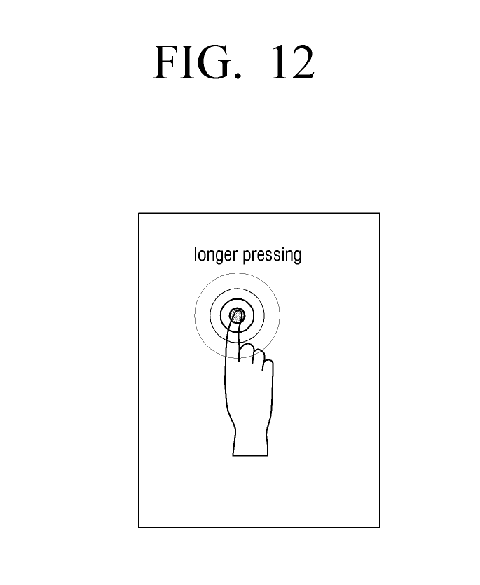

FIG. 12 illustrates a long pressing operation of a point over a threshold time.

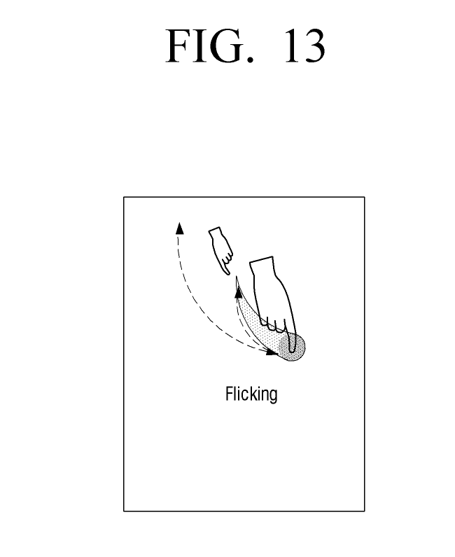

FIG. 13 illustrates a flicking operation in which a user touches a point and suddenly moves to one direction.

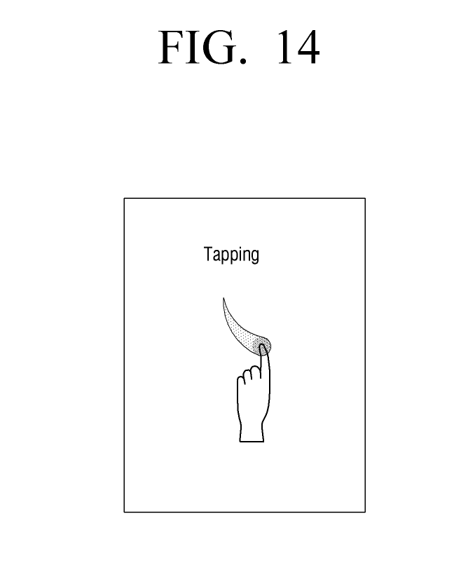

FIG. 14 illustrates a tapping operation in which a user softly touches the screen with a fingertip.

As described above, a user can select a block by touching the screen in various fashions.

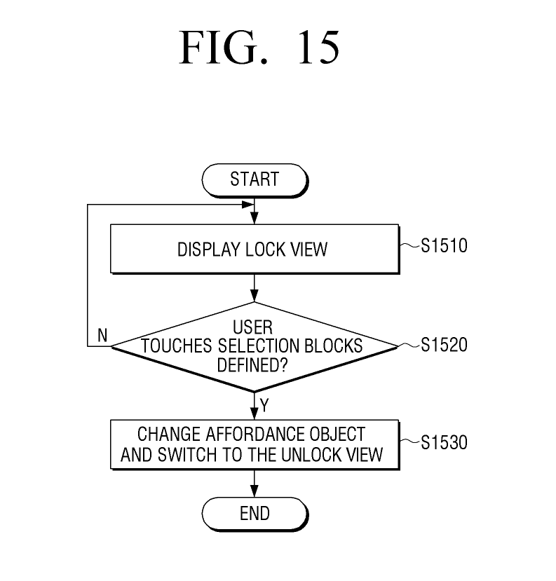

FIG. 15 is a flowchart illustrating an unlocking method according to an embodiment of the present invention.

Referring to FIG. 15, the display apparatus displays a lock view including an affordance object in the lock status in step S1510. As described above, the affordance object may be realized in a block pattern including a plurality of selection blocks to induce a user's touch. For example, the affordance object can be generated in the various shapes illustrated in FIGS. 2 through 5.

In step S1520, when the user touches the selection blocks of the affordance object on the screen using a finger or a touch pen, the affordance object is changed to represent the display state change of the touched blocks in step S1530.

Herein, the display state change can be variously realized, such as 3D-2D image conversion, image turnover, display change to the inactive state, color and size adjustment, etc.

When the affordance object is changed, the unlock view is displayed. The unlock view can be realized in various view types, as described above.

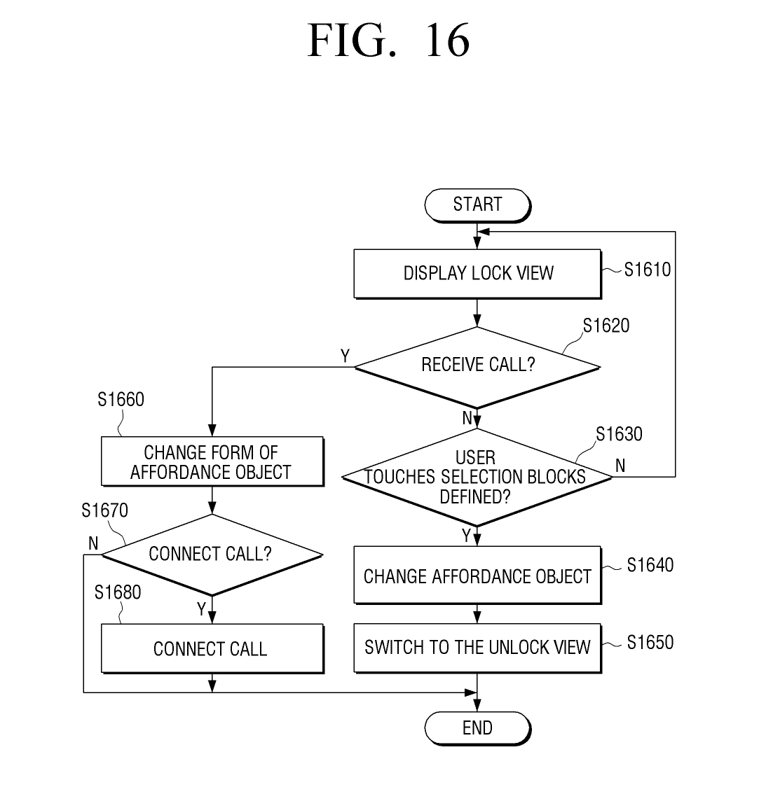

FIG. 16 is a flowchart illustrating an unlocking method according to another embodiment of the present invention.

Referring to FIG. 16, a lock view is displayed in step S1610. When a call is received in step S1620, the form of an affordance object is changed in step S1660. For example, the affordance object can be changed to move the locations of the selection blocks or to add the new selection blocks as illustrated in FIG. 7.

The user can determine whether to connect the call by touching the affordance object of the changed form in step S1670. When the call connection function is selected, the call is connected in step S1680, and the call connection view is displayed. However, when the call connection rejection function is selected in step S1670, the call connection is rejected.

When no call is received in step S1620 and the user touches the defined selection block in step S1630, the display apparatus changes the affordance object to change the display state of the touched selection block in step S1640, releases the lock status, and then switches to the unlock view in step S1650.

While the plurality of the affordance objects are displayed when the call is received in FIG. 16, other various operation modes than the call reception mode can be provided. Upon entering such operation modes, the display apparatus can further display the affordance object corresponding to the corresponding operation mode.

When the call is received or the operation mode is changed outside of the lock status, the affordance object including the corresponding selection block can be displayed.

The affordance object displayed in the lock view and the affordance object displayed when the call is received or the other operation mode is switched can be realized in the same or different form according to embodiments.

As such, since the user releases the lock by touching a certain part of the affordance object, the fixed part is not repeatedly used to release the lock. Since the affordance object varies based on the random determination, the lock can be released by evenly touching the screen. Thus, partial degradation of the touch panel can be prevented, and the user may enjoy releasing the lock, thus maximizing user satisfaction.

A program for executing the unlocking methods according to various embodiments of the present general inventive concept can be separately provided and recorded to a recording medium. An apparatus mounted with the recording medium can fulfill the unlocking methods by executing the corresponding program.

In detail, the program for executing the unlocking methods can be contained in various recording media readable by the terminal, such as a Random Access Memory (RAM), a flash memory, a Read Only Memory (ROM), an Erasable Programmable ROM (EPROM), an Electronically Erasable and Programmable ROM (EEPROM), register, hard disc, removable disc, memory card, Universal Serial Bus (USB) memory, and Compact Disc ROM (CD-ROM).

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

1. A display apparatus comprising:
a display unit for displaying a lock view comprising an affordance object including a plurality of blocks, the plurality of blocks including a plurality of selection blocks; and
a control unit for controlling the display unit to alter a display state of each of the plurality of the selection blocks, as each of the plurality of selection blocks is touched by a user, and to switch from the lock view to an unlock view, after all of the plurality of selection blocks are touched.

2. The display apparatus of claim 1, wherein the control unit randomly determines the selection blocks from the plurality of the blocks and controls the display unit to display the determined selection blocks to be differentiated from non-selection blocks from the plurality of the blocks.

3. The display apparatus of claim 1, wherein the plurality of the blocks each individually displays content, and
wherein the control unit determines a block for displaying updated content, among the plurality of the blocks, as one of the selection blocks and controls the display unit to display the determined selection block to be differentiated from non-selection blocks from the plurality of the blocks.

4. The display apparatus of claim 1, wherein the affordance object includes an image divided into the plurality of blocks, and
wherein the control unit controls the display unit displays the affordance object image, without being divided into the plurality of blocks, after all of the plurality of selection blocks are touched.

5. The display apparatus of claim 4, further comprising: a storage unit for storing information of a plurality of images,
wherein the control unit randomly selects the image from one of the plurality of the images stored to the storage unit.

6. The display apparatus of claim 1, wherein each of the plurality of blocks individually displays content.

7. The display apparatus of claim 1, further comprising a communication unit for receiving a call connection request,
wherein, when the call connection request is received while the lock view is displayed, the control unit controls the display unit to display a first block mapped to a call connection function and a second block mapped to a call connection rejection function among the plurality of the blocks.

8. The display apparatus of claim 1, wherein each of the plurality of the selection blocks is represented as a 3D image having a depth different from the lock view, and
wherein the control unit controls the display unit to convert a selection block touched by the user among the plurality of the selection blocks, to a 2D image having a same depth as the lock view.

9. A method for releasing a lock status of a display apparatus, the method comprising:
displaying a lock view comprising an affordance object including a plurality of blocks, the plurality of blocks including a plurality of selection blocks;
altering a display state of each of the plurality of the selection blocks, as each of the plurality of selection blocks is touched by a user; and
switching from the lock view to an unlock view, after all of the plurality of selection blocks are touched.

10. The method of claim 9, wherein the selection blocks are randomly determined from the plurality of the blocks, and the determined selection blocks are displayed differently than non-selection blocks.

11. The method of claim 9, wherein the plurality of the blocks each individually displays content, and a block for displaying an updated content among the plurality of the blocks is determined as one of the selection blocks.

12. The method of claim 9, further comprising:
generating the affordance object by dividing an image into the plurality of blocks; and
displaying the affordance object as the image, without being divided into the plurality of blocks, after all of the plurality of selection blocks are touched.

13. The method of claim 12, further comprising randomly selecting the image to be divided from a plurality of prestored images.

14. The method of claim 9, further comprising:
receiving a call connection request while the lock view is displayed;
displaying a first block mapped to a call connection function and a second block mapped to a call connection rejection function among the plurality of the blocks; and
performing an operation corresponding to a block selected from the first block and the second block.

15. The method of claim 9, wherein each of the plurality of the selection blocks is represented as a 3D image having a depth different from the lock view, and a selection block touched by a user among the plurality of the selection blocks is converted to a 2D image having a same depth as the lock view.
